(19) United States
(12) Patent Application Publication
(10) Pub. No.: US 2015/0317907 A1
(43) Pub. Date: Nov. 5, 2015

(54) COMPUTER-AIDED INTEGRATED EXAMINATION AND ASSIGNMENT SYSTEM AND METHOD

(71) Applicant: Way On Ho, Singapore (SG)

(72) Inventor: Way On Ho, Singapore (SG)

(21) Appl. No.: 14/265,359

(22) Filed: Apr. 30, 2014

(51) Int. Cl. G09B 7/00; G09B 5/12

(52) U.S. Cl. CPC G09B 7/00; G09B 5/12

(57) ABSTRACT

The present invention enables a teacher to author questions for examination and assignments so that students working the Internet or an Intranet can type their answers from their systems and submit for marks and feedbacks. For each question, teacher also provides standard answers which are coded. Once students submit their answers, their answers are compared against the standard answers and, after evaluation of each student's response in relation to a teacher-authored standard answer, marks are awarded to the students and the system provides automatic feedback. The system further provides for re-analysis of student's answer if satisfactory answers are not written by students and the student's answer are compared against a database of wrong answers owing to misconception, logical problems etc. The present invention further provides for inclusion of alternative answers detected in student's answer and sends such alternative answers to the examination/assignment originator for inclusion in the standard answer.

### FIELD OF THE INVENTION

The present invention generally relates to computer based examination. More particularly, the present invention relates to a system and a method for administering a computer based integrated examination and assignment process that provides auto-marking and feedback.

### BACKGROUND OF THE INVENTION

Examination is regarded to be the best tool to determine the extent to which the educational objectives have been achieved. There are various types examination methods used to assess academic progress, for example, paper-pencil-based examinations, assignments, presentations etc. In the last decade, the rapid progress made in the fields of computer science, particularly in the field of natural language processing (NLP), combined with the advancement in information technology has brought in a shift from traditional paper-pencil-based system to computer-aided system of examinations.

Computer-aided examinations are the form of assessment in which the computer is an integral part of examination's questions delivery, student's response, storage of data, marking of response or reporting of results from a test or exercise. Computer-aided examination tools have reduced the burden of teachers and have helped to conduct examinations purposefully. Computer-aided examinations can be used to promote more effective learning by testing a range of skills, knowledge and understanding.

Computer-aided examination offers several advantages over traditional paper-based tests. Computer-aided assessment provides opportunities to measure complex form of knowledge and reasoning that is not possible to engage and assess through traditional methods. However, the existing computer aided methods have certain limitations.

Problems with such known systems include but not limited to how to automatically analyze and mark such responses or answers received from a student and how to automatically provide feedback to students. An automatic feedback mechanism should be available to inform a student when the student strays from the teacher's authored correct answer, or to reinforce through feedback, the moment the student correctly completes a response. The system should also have the capacity to update itself over time.

Therefore, given the above, what is needed is a system and a method for an computer-aided integrated examination and assignment process, designed for educators and students, that takes advantage of handheld computers, desktop/laptop computers and the increasing presence of Internet access and that provides auto-analysis, auto-marking and feedback functions.

The referenced shortcomings are not intended to be exhaustive, but rather are among many that tend to impair the effectiveness of previously known techniques in computer-aided examination systems; however, those mentioned here are sufficient to demonstrate that the methodologies appearing in the art have not been satisfactory and that a significant need exists for the techniques described and claimed in this disclosure.

### OBJECTS OF THE INVENTION

An object of the present invention is to provide a computer-aided integrated examination and assignment system and method which analyses, auto marks and provides feedback on students' answers or academic assignments.

Another object of the present invention is to provide a computer-aided integrated examination and assignment system and method which updates itself when it encounters new and acceptable answers.

A further object of the present invention is to provide a computer-aided integrated examination and assignment system and method of transmitting examination and assignment related materials to students.

A still further object of the present invention is to provide a computer-aided integrated examination and assignment system and method that allow multiple types of users to access the features of the system as a function of their predefined role within the framework of the system (e.g. student, teacher, administrator).

A still another object of the present invention is to provide a computer-aided integrated examination and assignment system and method that are scalable in order to accommodate increasing numbers of users, such that system responsiveness is not materially degraded as the number of users of the system grows to an increasingly large number.

A further object of the present invention is to provide a computer-aided integrated examination and assignment system and method that can be easily integrated with existing computer network and backend systems with minimal disruption to existing operations and systems.

A still further object of the present invention is to provide a computer-aided integrated examination and assignment system and method that can accommodate a variety of diverse educational fields (e.g. academic, tertiary or professional) without requiring substantial modifications to the system.

These as well as other objects of the present invention are apparent upon inspection of this specification, including the drawings and appendices attached hereto.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The present invention enables a teacher to author questions for examination and assignments so that students working the Internet or an Intranet can type their answers from their systems and submit for marks and feedbacks. For each questions, teacher also provides standard answer which are coded. Once students submit their answers, their answers are compared against the standard answers and after evaluation of each student's response in relation to a teacher-authored standard answer marks are awarded to the students and the system provides to supply automatic feedback accordingly.

The present invention further provides for re-analyse of student's answer scripts if satisfactory answers are not written by students and the student's answer scripts are compared against a data base of wrong answers owing to misconception, logical problems etc.

The present invention further provides for inclusion of alternative answers detected in student's answer script and sends such alternative answers to the examination/assignment originator i.e. teacher for inclusion in the standard answer.

To the accomplishment of the foregoing and related ends, certain illustrative aspects of the disclosed invention are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF DRAWINGS

FIG. 1 is a block diagram of the system of the present invention in accordance to one embodiment;

FIG. 2 shows a flow chart in accordance to one embodiment of the present invention;

### DETAILED DESCRIPTION OF THE INVENTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

Unless specifically stated otherwise, as apparent from the following discussions, it is appreciated that throughout the specification discussions utilizing terms such as “processing”, “computing”, “determining”, “calculating” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. The term server may refer to a single server or to a functionally associated cluster of servers.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Embodiments of the present invention are described herein in the context of a computer-aided system and method for transmitting examination and assignment related materials to students so that the students can type their answers and submit back. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

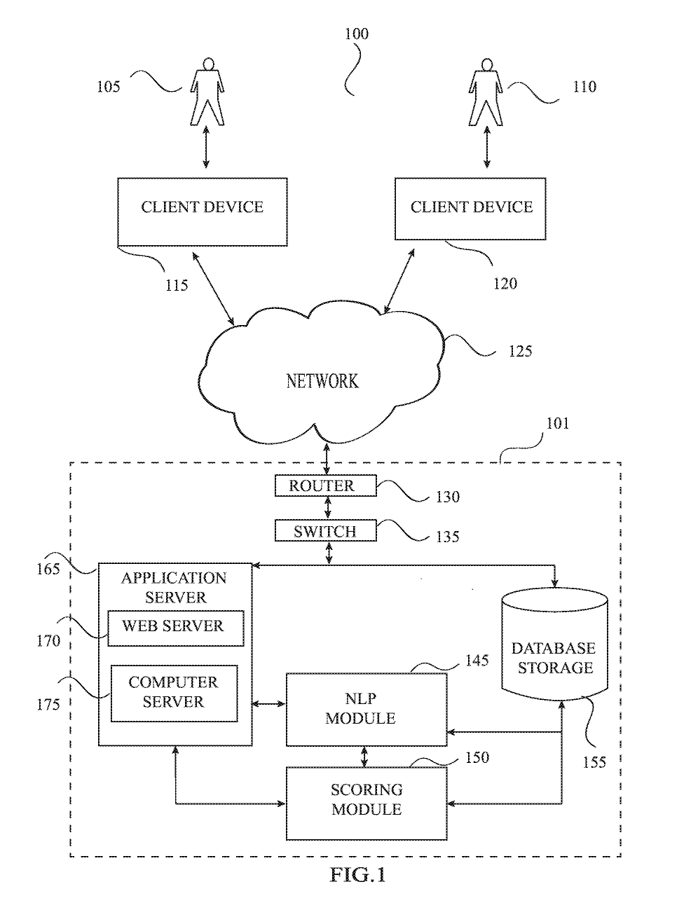

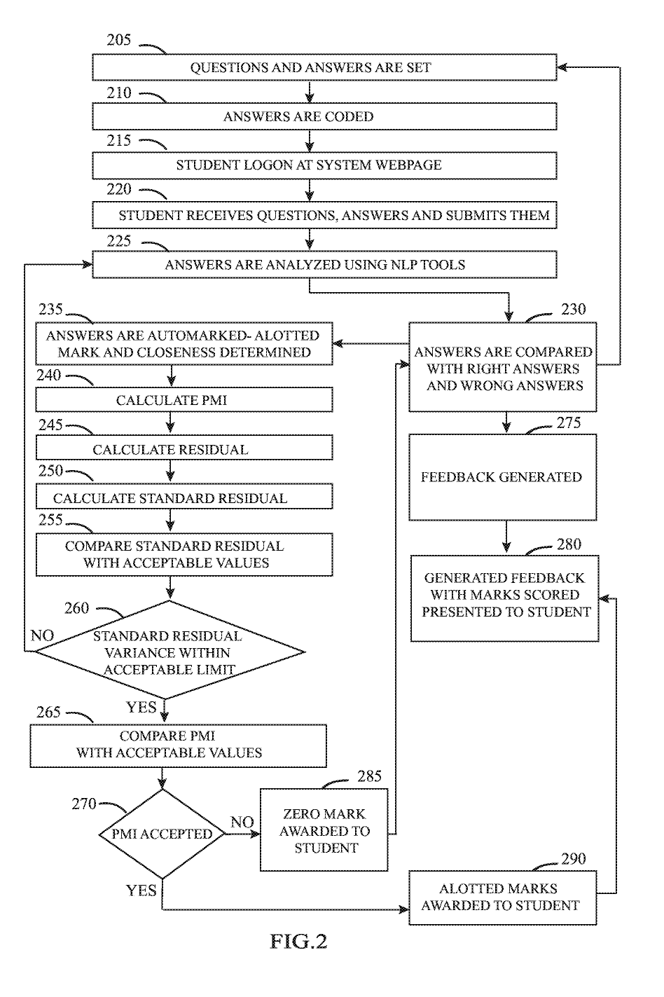

The following description about the invention is made with reference to FIG. 1 and FIG. 2.

FIG. 1 illustrates the general architecture of a system 100 that operates in accordance with one embodiment of the present invention. As shown in FIG. 1, pluralities of graphical user interface (GUI) displays are presented on a plurality of client devices 115 and 120 connected to an apparatus 101 via the network 125. The client device 115 and 120 may be any device capable of presenting data, including, but not limited to, personal computers, server computers, mobile devices, tablets, hand-held or laptop devices, smart phones or personal digital assistants. As used herein, the term “Internet” generally refers to any collection of distinct networks working together to appear as a single network to a user. The term refers to the so-called world wide “network of networks” that is connected to each other using the Internet protocol (IP) and other similar protocols. The Internet provides file transfer, remote log in, electronic mail, news and other services. As described herein, the exemplary public network 125 of FIG. 1 is for descriptive purposes only. Although the description may refer to terms commonly used in describing particular public networks such as the Internet, the description and concepts equally apply to other public and private computer networks, including systems having architectures dissimilar to that shown in FIG. 1.

The apparatus 101 is connected to the network 125 through a router 130 and a switch 135. As is well known in the relevant art(s), routers forward packets between networks. The router 130 forwards information packets between the apparatus 101 and client devices 115 & 120 over the network 125. The switch 135 may act as a gatekeeper to and from the network 125. The components appearing in the apparatus 101 refer to an exemplary combination of those components that would need to be assembled to create the infrastructure in order to provide the tools and services contemplated by the present invention. As will be apparent to one skilled in the relevant art(s), all of components “inside” of the apparatus 101 may be connected and may communicate via a wide or local area network (WAN or LAN).

The apparatus 101 includes an application server 165, a Natural Language Process (NLP) module 145, a scoring module 150 and a database storage 155. The application server 165 comprises a web application server 170 and a computer server 175 that serves as the application layer of the present invention.

The Web application server 170 is a system that sends out web pages in response to Hypertext Transfer Protocol (HTTP) requests from remote browsers (i.e. users of the client devices 115 and 120). That is, the Web server 170 provides the GUI to users of the system in the form of web pages.

As will be appreciated by those skilled in the relevant art(s), this configuration of router 130 and switch 135 is flexible and can be omitted in certain embodiments. Additional routers and/or switches can also be added.

The computer server 175 may include a central processing unit (CPU), a random access memory (RAM) temporary storage of information, and a read only memory (ROM) for permanent storage of information. Computer server 175 may be generally controlled and coordinated by an operating system software. The operating system controls allocation of system resources and performs tasks such as processing, calculating, scheduling, memory management, networking, and I/O services, among things. Thus, the operating system resident in system memory and executed by CPU coordinates the operation of the other elements of the apparatus 101.

Although the description of the computer server 175 may refer to terms commonly used in describing particular computer servers, the description and concepts equally apply to other processing systems, including systems having architectures dissimilar to that shown in FIG. 1. The databases storage 155 stores interrelationship data, question and answer data, student data, system data and any other data item required by the other components of the apparatus.

In a preferred embodiment of the present invention, user 105 is a teacher or a system administrator who has access to apparatus 101, to store examination and assignment related data through client device 115 as in step 205 of flow chart shown in FIG. 2. Teacher or administrator 105 would also provide a set of standard answers to each examination question or assignment and the same will be transferred to apparatus 101 through network 125. As in step 210 of work flow shown in FIG. 2, with the help of the NLP module 145, the apparatus 101 of FIG. 1 of the present invention codifies the standard set of answers with syntactic, semantic, logical, grammatical, numerical and symbolic markers and the data gets stored in database storage 155.

It would be obvious to any person skilled in the art that any NLP tool known in art may be used for this marking task to satisfy the intended use of the system 100.

Referring to FIG. 1 and FIG. 2 together, when a student 110 visits the webpage provided by the system of the present invention, as in step 215 of FIG. 2, on a client device 120 (FIG. 1), the student 110 is able to log onto his/her account provided by the system 100 if the student 110 is already registered with the system 100. Otherwise, if the user is not already registered, the user is asked to register to gain access to the system 100.

Referring to FIG. 1 and FIG. 2 together, once a student 110 logs onto his or her account, as per his/her preferred subject/topic/level, the student 110 will be presented a set of questions which has already been set by the teacher or administrator 105 as in step 205. The student 110 then writes answer to a question presented to him/her on the space marked in the webpage provided by the system 100 that appears on the graphical user interface on client device 120. The student 110 then submits the answer to the question by clicking on the “submit” button provided on the webpage. The submitted answer travels to the apparatus 101 through network 125.

Referring to FIG. 1 and FIG. 2 together, in a preferred embodiment, the answer submitted by student 110 is now analyzed with the help of NLP module 145. The NLP module 145 uses tools such as syntactic parsers to analyze the syntactic form of a text, discourse parsers to analyze the discourse structure of a text and lexical similarity measures to analyze word use of a text etc. to analyze the answers as in step 225 of FIG. 2.

As in step 230 of FIG. 2, referring to FIG. 1, similarity between answer submitted by the student 110 and the corresponding standard set of answers stored in database storage 155 is compared in terms of syntactic, semantic, logical, grammatical, numerical and symbolic similarities. Based on the similarities found, as in step 235, the scoring module 150 determines mark to be allotted in points (say, for example, 5 out of total mark 10 set for the question) hereinafter referred to as Allotted Mark or AM in short, and closeness in percentage terms (say for example 60% if the student's answer is 60% close to the standard answer), hereinafter referred to as “Closeness”. Based on these two parameters i.e. based on AM and “Closeness”, for a set of answers submitted against the same question by plurality of students registered to system 100 of the present invention, the scoring module 150 then obtains a multivariate equation. After the multivariate equation is obtained, the individual “AM” and “Closeness” of each student is substituted into the multivariate equation to obtain a “Predicted Mark Index”, hereinafter referred to as PMI for each student's answer (say the PMI, so derived, based on AM value 5 and “Closeness” value 60%, for the present example, is 6.5) as in step 240.

In step 245 of FIG. 2, the PMI value is subtracted from the corresponding AM value to obtain the Residual value (for the present example, Residual value would be −1.5 obtained by subtracting PMI value 6.5 from AM value 5). In the next step i.e. in step 250, value of Standard Residual is obtained corresponding to the answer. The Standard Residual is arrived at by dividing the Residual value calculated at step 245 (−1.5 for the present example) by the Standard Deviation of the Residual values calculated corresponding to a set of answers submitted against the same question by plurality of students registered to system 100 (FIG. 1) of the present invention. The objective of calculating Standard Residual is to check accuracy of the AM calculated by the apparatus 101 (FIG. 1) of the present invention. As in step 255, the apparatus 101 of the present invention compares whether value of Standard Residual corresponding to an answer lies in the acceptable range or not. In a preferred embodiment, as in step 260, the apparatus 101 accepts the AM value as correct if value of corresponding Standard Residual is found to be within a value of −1 Standard Residual. If the Standard Residual is found to be less than −1, the system re-analyzes and re-compares the student's answer as in step 225 and 230. In a preferred embodiment, in such cases where variance is found to be below acceptable level (i.e. below −1 in the present example), the student's answer is physically checked by a teacher.

As would be obvious to any person skilled in the art, any statistical tool that exists in the art may be used to perform these calculations.

Referring to FIG. 1 and FIG. 2, once the correctness of the calculated AM value is found to be satisfactory, the apparatus 101 goes on to check whether the PMI calculated for the answer of student 110 lies within acceptable range of predetermined PMI values or not as in step 265. As in step 270, if the PMI value is found to be within acceptable range of predetermined PMI values then the system of the present invention awards the AM (5 in the present example) as the mark obtained by the student as in step 290. If the PMI value is found to be lying outside the acceptable range of predetermined PMI values, then zero mark will be awarded to the student 110 as in step 285 and the answer will be reassessed against a database of wrong answers stored in the database storage 155 as in step 230 in terms of misconceptions of theory, information gaps, wrong spellings or improper explanation of key concepts. If any of these are detected, a feedback will be generated as in step 275 which would contain a report on the possible mistakes on the part of the student 110 in answering the question. The feedback generated as in step 275 would contain comparison of student's answer to a standard answer according to whether the student's answer is fully correct, partially correct or completely wrong.

In a preferred embodiment of the present invention, a final feedback with marks scored will be presented to the student on client device 120 as in step 280 of FIG. 2.

As can be understood from the above description of the preferred embodiments, the system 100 of computer-aided examination and assignment of the present invention is a dynamic one which updates itself in the course of time as different types of answers submitted by students against the same question get stored in the database which would be used for comparison of newly submitted answers by students in the future.

Additionally, other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-aided integrated examination and assignment system, comprising:
at least one client device having a display unit to display a webpage and an input device for allowing entering of plurality of questions and corresponding at least one standard answer against each said question by a teacher;
at least one client device having a display unit to display said question on a webpage and an input device for allowing a student to enter an answer;
an apparatus configured to analyze said answer received from said student, to compare said answer received from said student with at least one said corresponding standard answer, do auto-marking to said answer received from said student and provide a feedback to said student on said client device; and
a network which establishes communication between said at least one client device and said apparatus;
wherein said computer-aided integrated examination and assignment system updates itself over time with increasing numbers of standard answers.

2. The computer-aided integrated examination and assignment system as in claim 1, wherein said network is an internet.

3. The computer-aided integrated examination and assignment system as in claim 1, wherein said teacher is an administrator.

4. The computer-aided integrated examination and assignment system as in claim 1, wherein said network is an intranet.

5. The computer-aided integrated examination and assignment system as in claim 1, wherein said standard answer against each said question is coded.

6. The computer-aided integrated examination and assignment system as in claim 1, wherein said each student's answer is analysed to obtain an allotted mark and a closeness.

7. The computer-aided integrated examination and assignment system as in claim 6, wherein said allotted mark and said closeness obtained by said each student is used to obtain a predicted mark index.

8. The computer-aided integrated examination and assignment system as in claim 7, wherein a residual value is obtained from said allotted mark and said predicted mark index.

9. The computer-aided integrated examination and assignment system as in claim 8, wherein a standard residual is obtained from a plurality of said residual values.

10. The computer-aided integrated examination and assignment system as in claim 9, wherein said standard residual is compared with a predetermined set of values.

11. The computer-aided integrated examination and assignment system as in claim 7, wherein said predicted mark index is compared against a predetermined set of values to accept or reject said predicted mark index.

12. The computer-aided integrated examination and assignment system as in claim 7, wherein said allotted mark is awarded to said student's answer when said predicted mark index is accepted.

13. The computer-aided integrated examination and assignment system as in claim 7, wherein zero mark is awarded to said student's answer when said predicted mark is rejected.

14. The computer-aided integrated examination and assignment system as in claim 1, wherein said student's answer is re-analysed and compared against a database of wrong answers owing to misconception and logical problems.

15. The computer-aided integrated examination and assignment system as in claim 1, wherein sections of said student's answer that are inaccurate, suffering misconceptions and logical problem are highlighted in said feedback.

16. The computer-aided integrated examination and assignment system as in claim 1, wherein said system allow multiple types of users to access the features of the system as a function of their predefined role within the framework of said system.

17. The computer-aided integrated examination and assignment system as in claim 1, wherein said system is scalable in order to accommodate increasing numbers of said teachers and said students.

18. The computer-aided integrated examination and assignment system as in claim 1, wherein responsiveness of said system is not materially degraded as the number of said teachers and said students grows to an increasingly large number.

19. The computer-aided integrated examination and assignment system as in claim 1, wherein said system integrates with an existing computer network and backend systems with minimal disruption to existing operations and systems.

20. The computer-aided integrated examination and assignment system as in claim 1, wherein said system accommodates a variety of diverse educational fields without requiring substantial modifications to said system.

21. A method for computer-aided integrated examination and assignment, said method comprising the steps of:
setting up of at least one question and at least one corresponding standard answer for examination and assignment through at least one client device by a teacher;
transferring said examination and assignment related data and set of standard answers to an apparatus through a network;
codifying said set of standard answers by said apparatus with syntactic, semantic, logical, grammatical, numerical and symbolic markers;
storing of said data in a database storage;
logging on a webpage provided by said apparatus through said network on said client device by at least one student;
presenting said at least one question as per said student's preferred subject, topic and level on said webpage;
writing of an answer by said student to said question presented to said student on a space marked in said webpage that appears on said client device;
submitting of said answer to the question by clicking on a submit button provided on said webpage;
travelling of submitted answers to said apparatus through said network;
comparing of submitted answer and said at least one standard answer;
analyzing of student answer to obtain a allotted mark and a closeness;
using of said allotted mark and said closeness to compute a predicted mark index for said student's answer to said question;
computing a residual value from said allotted mark and said predicted mark index;
computing a standard residual from said plurality of residual values;
comparing said standard residual with a predetermined set of values;
comparing said predicted mark with a predetermined set of values to accept or reject said predicted mark;
awarding said allotted mark to said answer of said student if said predicted mark index is acceptable;
awarding zero mark to said answer of said student if said predicted mark index is rejected;
providing a feedback with said allotted mark or said zero mark to said student on said webpage on said client device;

22. The method for computer-aided integrated examination and assignment as in claim 21, wherein alternative answers given by said student is detected and sent to teacher to include in said standard answer.

23. The method for computer-aided integrated examination and assignment as in claim 21, wherein said answer of said student is re-analyzed if said predicted mark index is not accepted.

24. The method for computer-aided integrated examination and assignment as in claim 21, wherein sections of said answer of said student that are inaccurate, suffering misconceptions and logical problem is highlighted in said feedback.

25. The method for computer-aided integrated examination and assignment as in claim 21, further comprises analysing submitted answer of said student by NLP module.

26. The method for computer-aided integrated examination and assignment as in claim 21, wherein said network is an internet.

27. The method for computer-aided integrated examination and assignment as in claim 21, wherein said network is an intranet.
